(19) United States
(12) Patent Application Publication
(10) Pub. No.: US 2016/0324128 A1
(43) Pub. Date: Nov. 10, 2016

(54) Bee Nest Surround with Multi-Piece Backing and Separate Attachable Side Walls

(71) Applicant: HWY 123 Farms Ltd., Carrot River (CA)

(72) Inventor: Brent D. Dean, Carrot River (CA)

(21) Appl. No.: 14/941,168

(22) Filed: Nov. 13, 2015

(30) Foreign Application Priority Data
May 8, 2015 (CA) 2890999

(51) Int. Cl. A01K 47/02

(52) U.S. Cl. CPC A01K 47/02

(57) ABSTRACT

A leafcutter bee nest block surround features a set of separate backing members and a set of separate side members connectable thereto in useful positions extending away from a common plane shared by the backing members and spanning along respective sides of a nest-block receiving area of the common plane. Each of the side members has a coupling end connectable to one or more of the backing members and a distal free end opposite to the attachment end. Each side member, at the attachment end thereof, comprises a coupling feature that is cooperable with a mating coupling feature at the perimeter of one or more of the backing members to couple the side member to the backing member in the useful position. The nest surrounds can be flat packed for efficient transport and storage and easily assembly through mating of the coupling features without external tools or equipment.

### CROSS REFERENCE TO RELATED APPLICATIONS

This application claims benefit under 35 U.S.C. 119(a) of Canadian Patent Application Serial No. 2,890,999, filed May 8, 2015.

### FIELD OF THE INVENTION

The present invention relates generally to a nest surround for a leafcutter bee nest block, and more particularly to such a bee nest surround which is assembled in a tool-free manner from a set of initially separate backing pieces and cooperable side wall pieces matable therewith.

### BACKGROUND

Breeding of leafcutter bees is known for pollinating agricultural crops. Nests are typically provided for the bees which consist of a rectangular block of material perforated with a large number of through holes. A backing sheet is typically provided for enclosing one side of the holes to provide a backing for the bees to begin nesting and egg laying in the holes in the block. Nest surrounds are typically provided to ensure that the nest block is mounted in a secure manner protected against parasites and rodents. Conventional nest surrounds include wooden boxes which are heavy and generally difficult for handling and storage or metal components that are complex and subject to corrosion.

Canadian Patent No. 2,070,938 to Eggerman et al proposes various constructions for a nest surround moulded of plastic material, which in most instances requires two separate components and separate fastening means to secure the components together, as well as a separate backing sheet. In one embodiment, a perimeter wall is formed which is rectangular in shape for surrounding the nest block in a mounted position in which backing bars extend across one side of the block and resilient retainer flanges overlap the opposing side of the block for securing the backing sheet. The continuous nature of the perimeter wall limits flexing movement of the retainer flanges and accordingly a snug fit cannot be achieved and the backing is required to be separate.

Applicant's prior Canadian Patent Application No. 2,455,741 disclosed another bee nest surround in which flexible side wall members are integrally formed with a backing member atop which the nest block is seated during use. While the integral walls eliminated the need for user assembly of the surround, Applicant found that the flexible walls integrally upstanding from the backing member around the perimeter thereof resulted in an a inability to stack the units flat atop one another in a space efficient manner during transport and storage of the surrounds prior to use.

Accordingly, there remains room for further improvement in the field of leafcutter bee nest block surrounds.

### SUMMARY OF THE INVENTION

According to one aspect of the invention, there is provided a nest surround for a leafcutter bee nest block, the nest surround comprising:

a plurality of separate backing members each having an outer perimeter and being positionable at spaced apart positions from one another within a common plane to define a backing of the nest surround; and

a plurality of separate side members having a length dimension and a width dimension and being connected or connectable to the plurality of backing members in useful positions in which the width dimensions of the side members extend away from the common plane and the length dimensions span along respective sides of a nest-block receiving area of the common plane;

each of the side members having a coupling end connected or connectable to one or more of the backing members and a distal free end that is located opposite to the attachment end in the width direction of the side member;

wherein each side member, at the coupling end thereof, comprises a coupling feature that is cooperable or in cooperation with a mating coupling feature at the perimeter of one or more of the backing members to couple the side member to the backing member in the useful position.

Preferably each side member has the same coupling feature at the coupling end thereof and each backing member has the same mating coupling feature at the perimeter thereof, and each side member is connectable to any of said backing members.

Preferably the backing members are identical to one another.

Preferably each backing member has the coupling feature on multiple sides of the perimeter thereof.

Preferably the perimeter of each backing member has four sides, and each backing member has the coupling feature on three of the four sides.

Preferably each backing member has the coupling feature on only said three of the four sides.

Preferably the coupling features of the side members comprise male or female profiles, and the mating coupling features of the backing member comprises mating male or female profiles.

Preferably each side member comprises has a thin-walled structure of lesser thickness than each backing member, the coupling feature of each side member comprises a female profile, and the mating coupling feature of each backing member is a male profile fittable into said female profile.

Preferably each side member is flexible.

Preferably at least some of the coupling features of the side members, and respective mating coupling feature of the backing members, are arranged to angle respective side wall members inwardly over the common plane of the backing members in the useful position.

Preferably at least some of the mating coupling feature of the backing members are oriented at an obliquely offset angle relative to a primary plane that occupies the common plane during use of the nest surround.

Preferably at least some of the coupling features of the side members are oriented in an obliquely offset relation to a primary plane of the side member in which the width and length dimensions are measured.

Preferably a first one of either the coupling features of the side members or the matable coupling features of the backing members comprises a groove, and the other one of either the coupling features of the side members or the matable coupling features of the backing members comprises a mating tongue slidably receivable in the groove.

Preferably each groove and the mating tongue comprise opposite ones of a lock protrusion and a lock recess which cooperate with one another to secure the side wall in place under relative sliding of the tongue and groove into a secured position aligning the lock recess over the lock protrusion.

Preferably the lock protrusion comprises a ramp-shaped protrusion in the groove and the lock recess comprises a corresponding notch in the tongue.

Preferably each backing member comprises a plurality of feet projecting from a main body of the backing member to a side thereof opposite to that to which the side members extend in the useful position at locations situated inwardly from the mating coupling features of the backing member.

Preferably each backing member comprises sunken well that is offset from a main body of the backing member to a side thereof opposite to that to which the side members extend in the useful position, and a hanging slot is defined in a wall of the sunken wall that lies opposite to the main body for hanging support the nest surround through said hanger opening.

Preferably the coupling feature of each side member comprises a C-shaped channel opening laterally to one side of the side member, and each mating coupling feature of the backing members comprises a protrusion having a neck of reduced thickness relative to a head of the protrusion that is carried at an outer end of the neck, the C-shaped channel embracing around the head of the protrusion and being slidable along the neck thereof.

Preferably each side member comprises a Z-shaped profile at the distal end thereof that extends laterally to a same side of the side member as the coupling feature.

According to a second aspect of the invention, there is provided a nest surround for a leafcutter bee nest block, the nest surround comprising:

at least one backing member for defining a backing of the nest surround; and

a plurality of separate side members having a length dimension and a width dimension and being connected or connectable to the at least one backing member in useful positions in which the width dimensions of the side members extend away from the backing and the length dimensions span along respective sides of the backing;

each of the side members having a coupling end connected or connectable to the at least one backing member and a distal free end that is located opposite to the attachment end in the width direction of the side member;

each side member, at the coupling end thereof, comprising a coupling feature that is cooperable or in cooperation with a mating coupling feature at a perimeter of the at least one backing member to couple the side member to the at least one backing member in the useful position;

wherein the coupling features of the side members comprise male or female profiles, and the mating coupling features of the backing member comprises mating male or female profiles slidably engagable with the male or female profiles of the slide members for sliding movement between the male or female profiles and the mating male or female profiles along the perimeter of the at least one backing member.

Preferably the female profiles comprise respective grooves, and the male profiles comprise mating tongues slidably receivable in said grooves.

According to a third aspect of the invention, there is provided a nest surround for a leafcutter bee nest block, the nest surround comprising:

at least one backing member for defining a backing of the nest surround; and

a plurality of separate side members having a length dimension and a width dimension and being connected or connectable to the at least one backing member in useful positions in which the width dimensions of the side members extend away from the backing and the length dimensions span along respective sides of the backing;

each of the side members having a coupling end connected or connectable to the at least one backing member and a distal free end that is located opposite to the attachment end in the width direction of the side member;

each side member, at the coupling end thereof, comprising a coupling feature that is cooperable or in cooperation with a mating coupling feature at a perimeter of the at least one backing member to couple the side member to the at least one backing member in the useful position;

wherein a first one of either the coupling features of the side members or the matable coupling features of the at least one backing member comprises a groove, and the other one of either the coupling features of the side members or the matable coupling features of the at least one backing member comprises a mating tongue slidably receivable in the groove.

According to a fourth aspect of the invention, there is provided a nest surround for a leafcutter bee nest block, the nest surround comprising:

at least one backing member for defining a backing of the nest surround; and

a plurality of side members connected or connectable to the at least one backing member in useful positions in which the width dimensions of the side members extending away from the backing along respective sides of the backing;

wherein each side member has a Z-shaped profile at a distal end thereof that lies furthest from the backing in the useful position of the side member.

### BRIEF DESCRIPTION OF THE DRAWINGS

One embodiment of the invention will now be described in conjunction with the accompanying drawings in which:

FIG. 1 is an overhead plan view of an assembled surround for a leafcutter bee nest block.

FIG. 2 is a cross-sectional view of the surround of FIG. 1, as viewed along line A-A thereof.

FIG. 3 is a partial closeup view of the surround of FIG. 2 at encircled area B thereof.

FIG. 4 is an elevational view of a side wall member of the surround.

FIG. 5 is a partial isometric view of the side wall member of FIG. 4.

FIG. 6 is a perspective view of a backing member of the surround.

FIG. 7 is a partial closeup view of the backing member of FIG. 6 at encircled area C thereof.

FIG. 8 is an elevational view of the backing member of FIG. 6.

FIG. 9 is a bottom plan view of the backing member of FIG. 6.

FIG. 10 is a cross-sectional view of the backing member of FIG. 9, as viewed along line D-D thereof.

FIG. 11 is a partial closeup view of the backing member of FIG. 8 at encircled area E thereof.

FIG. 12 is a cross-sectional view similar to FIG. 2, but showing the surround in use with a bee nest block.

In the drawings like characters of reference indicate corresponding parts in the different figures.

### DETAILED DESCRIPTION

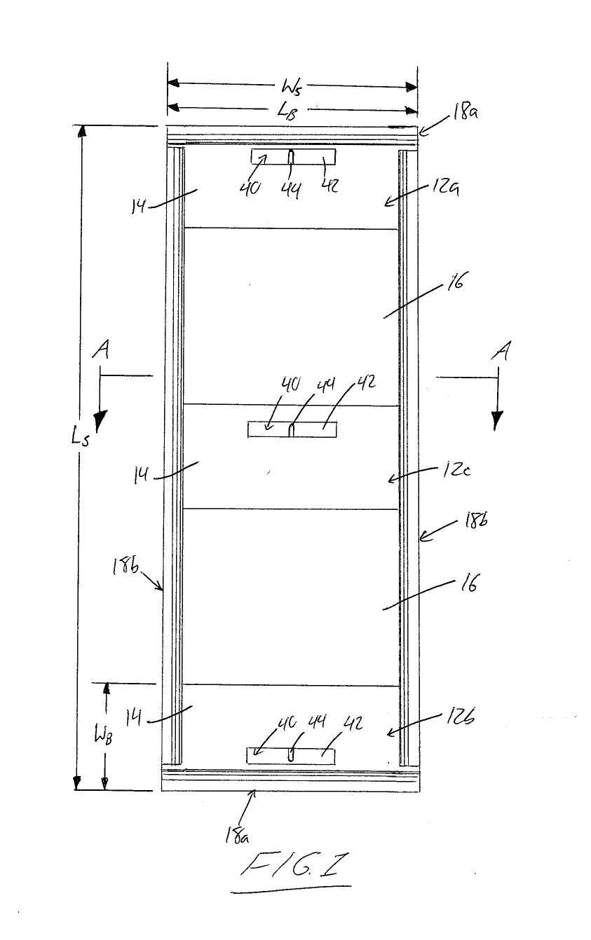

FIG. 1 illustrates one embodiment of a surround 10 for a bee nest block according to the present invention. Similar to the surround design disclosed in Applicant's prior aforementioned application, the surround features a backing over which a rectangular bee nest block 100 is placed, and a set side wall members projecting from the backing in a common direction to surround the bee nest block on all four sides thereof and thereby maintain the bee nest block in place over the backing. However, the present invention differs in that the side wall members are not integrally joined with the backing, and the backing is made up of a plurality of different pieces that are only interconnected with one another once assembled together with the side wall members. Such use of initially separate components allows packing and shipping of bee nest surrounds as flat-pack kits that are space-efficient and economical to transport. As outlined in further detail below, the components of the illustrated embodiment are easily assembled without requiring use of any separate tools or accessories.

With reference to the fully assembled surround 10 shown in FIGS. 1 and 2, the backing of the surround is made of three separate and identical backing members 12a, 12b, 12c that reside in a common plane with one another in the final assembled form of the surround. Each backing member features a rectangular main body 14 of planar form residing in the same common plane with the bodies of the other backing members. Each backing member has a length dimension L_{B} and a shorter width dimension W_{B} measured perpendicular thereto in the plane of the main body 14. In the assembled surround, the backing members reside parallel to one another in the common plane, and are spaced apart from one another in the width directions of the backing members. The length dimension L_{B} of each backing member slightly exceeds the width of a bee nest block for which the surround is intended.

In the illustrated embodiment, there are three backing members 12a, 12b, 12c, and the width W_{B} of each backing member is less than one third of the length of the rectangular bee nest block 100. In the assembled surround, two of the backing members 12a, 12b reside at opposing ends thereof so as to underlie the two opposing ends of the bee nest block 100, while the third backing member 12c resides beneath the bee nest block at an intermediate location generally centered between the two ends of the bee nest block. The length L_{B} of each individual backing member corresponds to the overall width W_{S} of the surround, and the individual widths W_{B} of the backing members occupy respective fractional portions of the overall length Lₛ of the surround. Within the common plane occupied by the backing members, open spaces 16 reside between the backing members 12a, 12b, 12c in the length direction Ls of the overall surround.

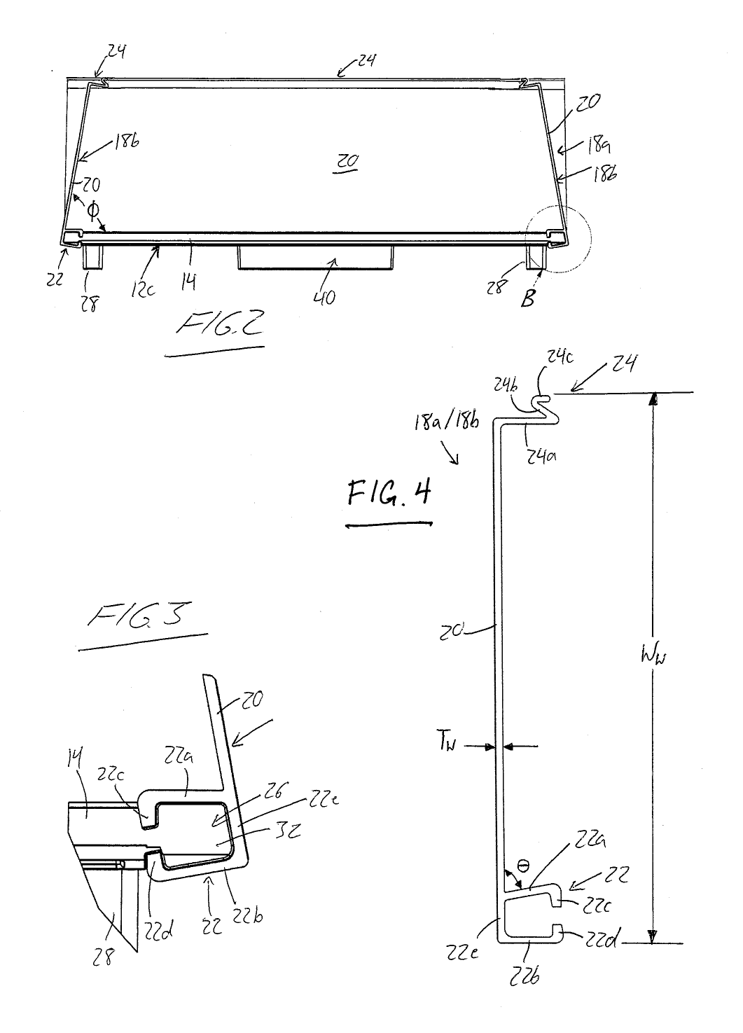

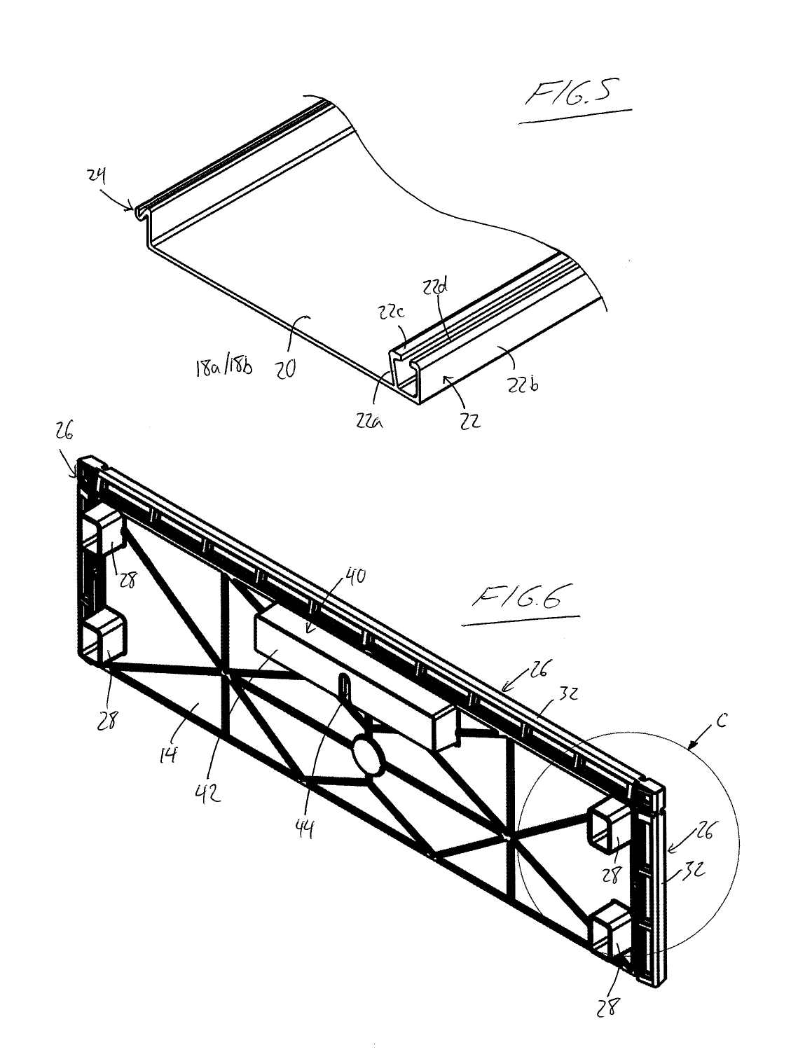

Each side wall member 18a, 18b has a width dimension W_{W}, and a length dimension measured perpendicular thereto. FIG. 4 illustrates a cross-sectional profile shared by each of the side wall members 18 of the surround in cross-sectional planes that are normal to the length dimension and parallel to the width dimension W_{W}. Each side wall member 18a, 18b has a planar wall 20 spanning the length L_{W} of the side wall member and defining the substantial majority of the width W_{W} thereof. A thickness T_{W} of the wall 20 measured perpendicularly to the length and width dimensions of the side wall member is a smallest of the side wall member's three dimensions, and is less than a thickness T_{B} of a main body 14 of each backing member 12a, 12b, 12c. Separated from one another in the width direction W_{W} of each side wall member are a coupling end 22 and a distal end 24 of the side wall member, each residing at a respective lengthwise edge of the planar wall 20. The coupling end 22 is defined as generally C-shaped channel running along the respective lengthwise edge of the planar wall 20, while the distal end 24 is defined as a generally Z-shaped channel running along the respective lengthwise edge of the planar wall 20.

In the cross-sectional planes of the side wall member, the C-shaped channel 22 features two legs 22a, 22b projecting laterally outward from the plane of the main wall 20 to a common side thereof, and a respective tongue 22c, 22d jutting inwardly from the distal end of each leg toward the opposing leg. The C-shaped cross-section of this channel 22 at the coupling end of the wall member 18 is completed by a central span 22e that joins together the two legs 22a, 22b and is a coplanar extension of the main wall 20 of the member. The C-shaped channel configuration at the coupling ends of the side wall members define female profiles for mating with corresponding male profiles on the backing members 12a, 12b, 12c, as described herein with greater detail below.

The Z-shaped channel 24 at the distal end of each side wall member extends laterally outward from the main wall 20 thereof to the same side as the C-shaped channel 22 at the coupling end. A base 24a of the Z-shaped profile is integrally joined to the respective lengthwise edge of the main wall 20 and reaches perpendicularly outward from the plane thereof. An intermediate portion 24b of the Z-shaped profile angles obliquely back toward the plane of the main wall 20 from the distal end of the base 24a on the side thereof opposite the C-shaped channel 24 of the member's coupling end. Finally, a terminal portion 24c of the Z-shaped profile extends parallel to the base 24a thereof from the end of the intermediate portion 24b opposite the base 24a.

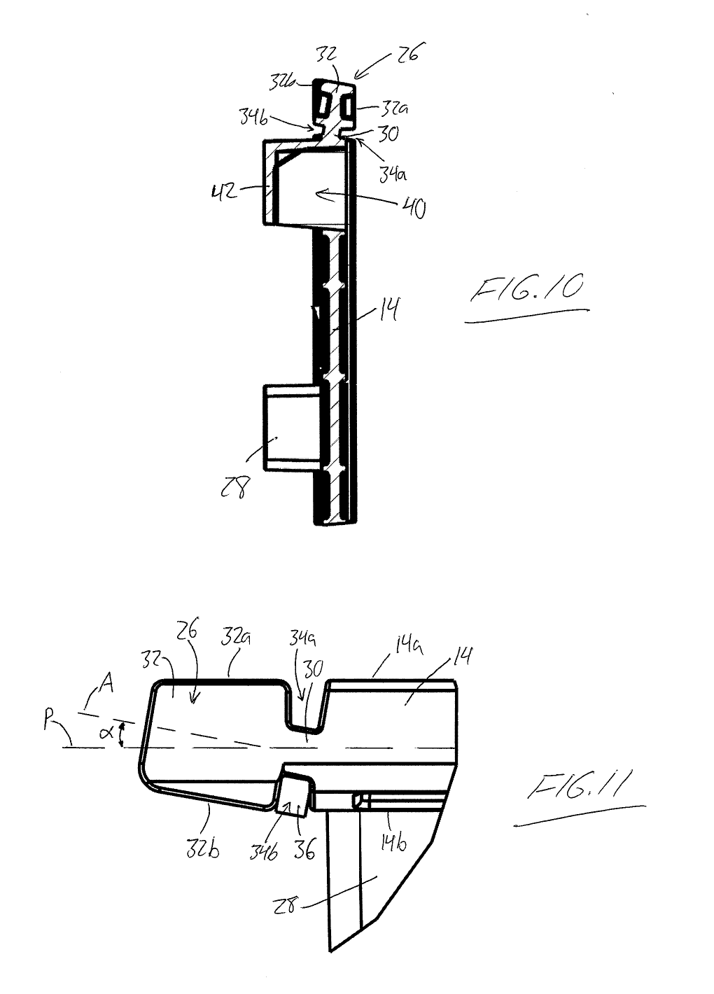

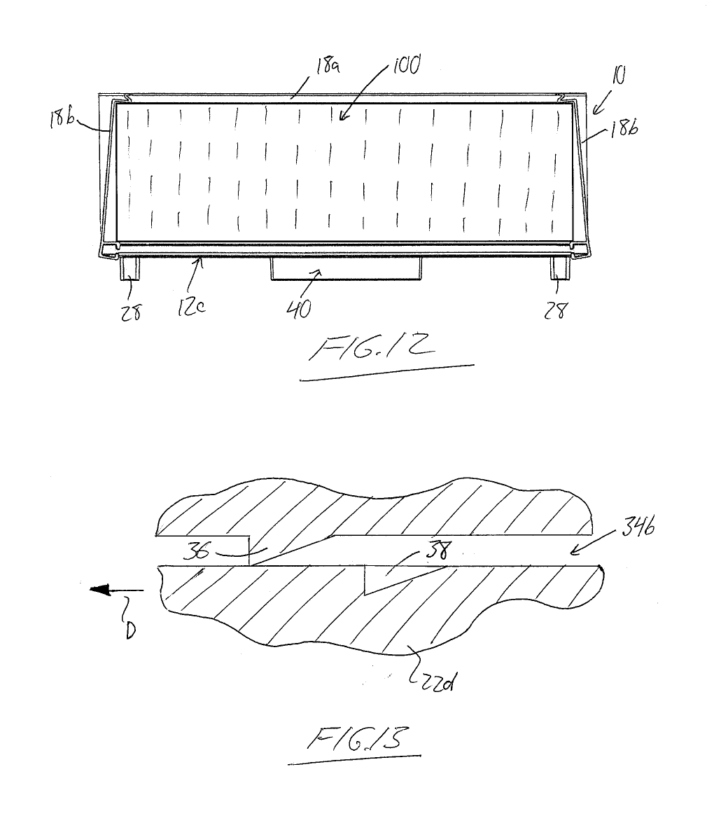

FIGS. 6 through 11 show one of the identical backing members in greater detail. Along three of the four perimeter edges of its rectangular main body 14, the backing member features a male protrusion 26 projecting outwardly from the respective perimeter edge of the main body 14. The protrusion spans the full length of this perimeter edge, and has a uniform cross-section over this full length of the perimeter edge. Two pairs of feet 28 project perpendicularly from the plane of the main body 14, with each pair of feet being spaced from the other in the lengthwise dimension L_{B} of the backing member so that the two pairs reside at opposing ends of the main body 14. Within each pair, the two feet 28 are spaced apart from one another in the width direction W_{B} of the backing member. The plane of each male protrusion 26 is obliquely offset from the plane of the main body 14, as denoted in FIG. 11 where an axis A denoting the direction in which one of the male protrusions projects from the main body 14 is angularly offset from the plane P of the main body 14 by angle α, which measures 10° in the illustrated embodiment, and between 5° and 15° degrees in other non-limiting embodiments. The protrusion 26 angles away from the plane P of the main body 14 to the side thereof opposite that on which the feet 28 are defined.

Where it initially projects from the main body 14, the protrusion 26 features a neck 30 that has a reduced thickness relative to that of the main body 14 so as to radiate outwardly therefrom at a location disposed intermediately between the major top and bottom faces 14a, 14b of the main body 14. The neck 30 defines the protruding axis A of the protrusion and the resulting angular offset angle α. A head 32 of the protrusion 26 is carried on an outer end of the neck 30 that is located distally from the main body 14. The head 32 is of greater thickness than the neck, whereby an upper groove 34a and a lower groove 34b are defined on opposite sides of the neck between the head 32 of the protrusion and the respective perimeter edge of the main body 14. The terms upper, lower, top, bottom, etc. are being used herein with reference to the illustrated orientation shown in FIGS. 2, 3, 8, 9 and 11, where the backing member is oriented horizontally with the feet 28 pointed downwardly toward the ground or other horizontal support surface on which the legs 28 of the backing member may be seated. However, these positional terms are not intended to denote a particular position or orientation in which the surround must be placed for use. The head 32 of the projection is somewhat trapezoidal in appearance, growing narrower in the outward direction away from the neck 30. In the illustrated embodiment, a topside 32a of the head 32 is parallel to the plane of the main body 14 coplanar with the top face 14a thereof, while the underside 32b of the head 32 is angularly offset from the plane of the main body 14 so as to be angled obliquely upward out of the plane of the parallel bottom face 14b of the main body 14, for example by angle α. An outer face 32c of the head 32 facing away from the main body 14 and joining together the topside and underside of the head is perpendicular to the underside 32b of the head in the illustrated embodiment, and therefore is sloped upwardly inward relative to the main body 14.

The female profile of the C-shaped channel 22 of each side wall member is shaped for mating cooperation with the male profile of any of the three protrusions 26 on any one of the backing members. An upper leg 22a of the C-shaped channel's legs is at an acute angle θ with the main wall 20 of the side wall member, while the lower leg 22b is perpendicular to the plane of the main wall 20, whereby the two legs are positioned at an oblique angle relative to one another so that the C-shaped channel gets narrower moving inwardly toward the plane of the main wall 20 from the tongue-equipped distal ends 22c, 22d of the channel legs 22a, 22b. This angle between the two legs of the C-shaped channel matches the angle between the topside 32a and underside 32b of the protrusion head 32. In select embodiments, θ and φ and complimentary angles with a sum of 90°, for example with θ measuring 80° in the illustrated embodiment, and 75° to 95° in other embodiments. The grooves 32a, 34b of each protrusion 26 span the entire length of the respective side of the backing member, and the two tongues 22c, 22d of the C-shaped channel 22 of any side wall member are slidable into the grooves 32a, 34b thereby receiving the male head 32 of the protrusion 26 in an embraced position inside the female channel 22 of the side member. The grooved protrusions 26 each therefore define a rail or track of along which one of the side wall members is slidable into its final installed condition with the backing member. One of the two longer sides of each backing member lacks a grooved projection, and is therefore not configured to couple with one of the side wall members.

Referring back to FIG. 1, there are two different types of side wall members 18a, 18b which differ from one another only in their length. Two shorter side wall members 18a are each engaged to a respective one of the two backing members 12a, 12b that reside at the opposing ends of the fully assembled surround. Specifically, these shorter side wall members 18a are each engaged to the respective backing member 12a, 12b at the longer one of the three male-profiled grooved sides of the respective backing member. Each one of the two longer side wall members 18b is engaged to all three of the backing plates 12a, 12b, 12c at one of the two shorter grooved/profiled sides thereof. The thicker backing members are substantially rigid molded plastic components, while the thinner side wall members are extruded plastic components having resilient pliability in the planar wall 20 to allow flexing thereof about a lengthwise axis thereof at or near the integral connection between the planar wall and the C-shaped channel.

Turning to FIG. 2, due to the angle of the C-shaped channel 22 of each side wall member relative to the main wall 20 thereof, the main wall 20 normally angles inwardly at an acute angle φ over the common plane shared by the backing members in the fully assembled state of the surround. The final installed positions between the longer side wall members 18b and the backing members are such that the longer side wall members 18b stop short of the shorter side wall members 18a so that the inwardly angled positions of the four side walls don't interfere with one another at the corners of the fully assembled surround.

As best shown in FIG. 4, the base 24a of the Z-shaped profile at the distal end of each side wall member extends further from the main wall 20 than the terminal portion 24c, whereby a rounded corner between the base 24a and the intermediate portion 24b is disposed beyond the end of the terminal portion 24c in the normal, relaxed, inwardly-angled positions of the side wall members shown in FIG. 2. As a result, lowering of a bee nest block downwardly toward the plane of the backing members from above the side wall members pushes downwardly and outwardly on the inwardly and downwardly sloped intermediate portion 24b of the Z-shaped profile 24, and then pushes outwardly against the rounded corner of the Z-shaped profile, thereby forcing the side wall members 18a, 18b outwardly from their relaxed inwardly-angled positions against the resilient bias of the planar walls 20 thereof. The width of the planar wall 20 of each side wall member slightly exceeds the thickness of the bee nest block, whereby lowering of the bee nest block into abutment with the backing members 12a, 12b, 12c allows the side wall members to resile back toward their inwardly angled positions, whereupon the bases 24a of the Z-shaped profiles on the side wall members 18a, 18b jut inwardly over the topside of the bee nest block from the perimeter thereof, thereby retaining the bee nest block adjacent to the backing members, as shown in FIG. 12. The terminal portion 24c of the Z-shaped profile on each side wall thereof presents a tab by which a user can pry back the Z-shaped profile of the resiliently flexible side wall out of its locking position over top of the nest block in order to enable removal of the nest block from the surround.

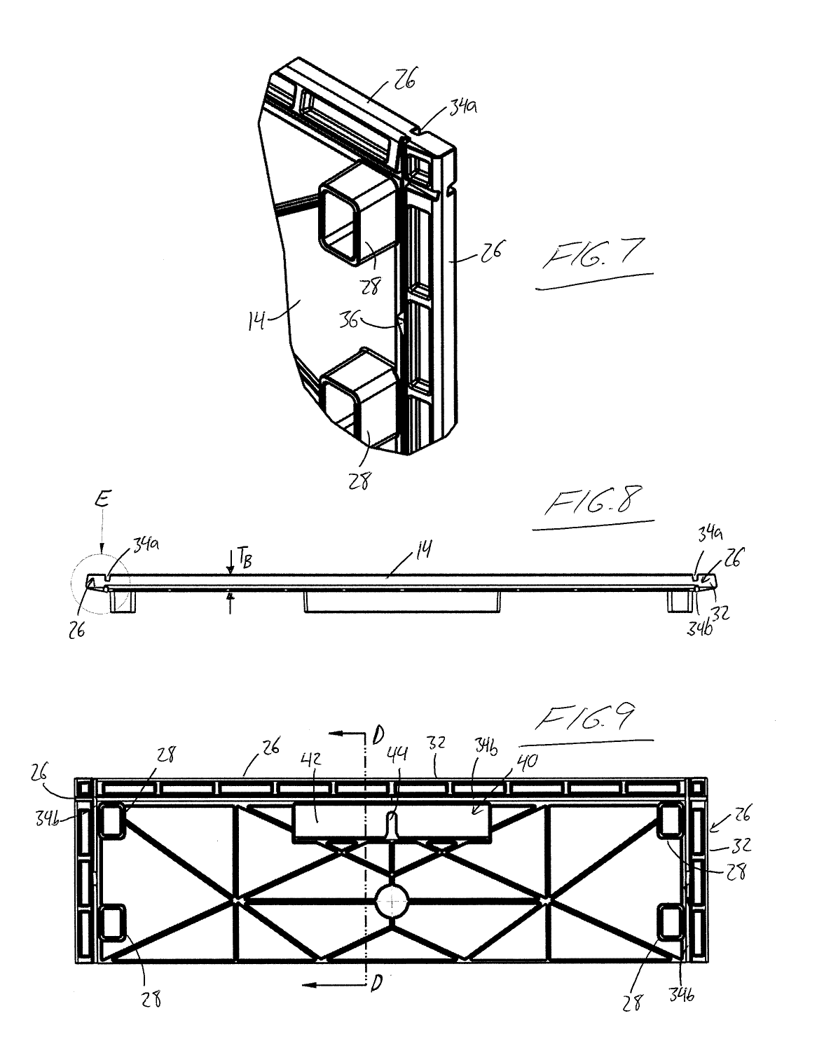

To lock the backing members and side wall members together in their assembled state, one of the two grooves 34a, 34b at each male protrusion 26 features a ramp shaped protrusion 36 therein at discrete point along the length of the groove. On such ramp 36 can be seen in FIG. 7. Each of the two shorter side wall members 18a has a respective ramp shaped notch or recess 38 in the respective one of the two tongues of its C-shaped channel, as shown schematically in FIG. 13, whereby sliding of the tongue notch into place over the ramp-shaped protrusion 36 in the direction D of the protrusion's increasing height causes the notch to snap in place over the protrusion. In this mated condition between the ramp and the notch, sliding of the interface in the reverse direction is blocked, and sliding of the interface in the same direction in resisted by the ramp. While the illustrated embodiment features placement of the ramp-shaped protrusion 36 in the lower groove 34b, such locking features may alternatively be employed at the upper groove 34a. Each of the two longer side wall members 18b has three ramp-shaped notches in the respective tongue, one for mating with the respective ramp-shaped protrusion of each backing member 12a, 12b, 12c. The ramp-like protrusions 36 and corresponding notches or recesses 38 thereby define locking features for securing the backing members and side wall members together in their assembled positions.

The feet 28 of each backing member are positioned inwardly from the wall-accepting peripheral grooves 34a, 34b of the protrusions 26 so that when the bee nest block of one surround is installed, and thereby forces the side wall members outwardly into their useful positions catching over the perimeter edges of the nest block, another bee nest surround can be stacked atop the first by seating the feet 28 of the second surround on the bee nest block of the first surround. The Z-shaped profiles catching over the topside of the bee nest block of the first surround block the feet 28 of the second surround from sliding off of the bee nest block.

Finally, each backing member features a sunken well 40 that is offset from the main body 14 to the same side thereof as the feet 28. The sunken well 40 is situated adjacent to the one of the backing member's longer sides that features a respective protrusion 26 and pair of grooves 34a, 34b. The sunken well 40 features a hanging wall 42 that is situated opposite and parallel to the underside 14b of the main body at a spaced distance therefrom. A hanging slot 44 extends into the hanging wall 42 from a free edge thereof that faces toward the opposing long side of the member at an open side of the well. The hanging slot 44 allows hanging of the assembled surround 10 by way of a hook, nail or other fastener onto which the hanging slot 44 is slid.

It will be appreciated that the kit of parts for assembling a surround of the present invention may employ a single backing member that has a coupling-capable profile around the full perimeter thereof to similarly mate with a set of four side wall members, instead of employ two or more separate backing members that only underlie a partial fraction of the overall area of the nest block 100 when the surround and nest block are assembled. Such an embodiment would still have the advantage of flat-pack capabilities and tool-free assembly. However, the use of separate backing members in the illustrated embodiment has the additional advantage of material and cost efficiency by reducing the total area over which the thicker plastic construction is used to define the male coupling profiles to which the thinner flexible side wall members are connectable. To protect the nest block 100 over its full area at the common plane of the backing members, a separate backing sheet (not shown) of thinner, cheaper material than the backing members may be laid atop the backing members to fully conceal the underside of the nest block.

Since various modifications can be made in my invention as herein above described, and many apparently widely different embodiments of same made within the scope of the claims without departure from such scope, it is intended that all matter contained in the accompanying specification shall be interpreted as illustrative only and not in a limiting sense.

1. A nest surround for a leafcutter bee nest block, the nest surround comprising:
a plurality of separate backing members each having an outer perimeter and being positionable at spaced apart positions from one another within a common plane to define a backing of the nest surround; and
a plurality of separate side members having a length dimension and a width dimension and being connected or connectable to the plurality of backing members in useful positions in which the width dimensions of the side members extend away from the common plane and the length dimensions span along respective sides of a nest-block receiving area of the common plane;
each of the side members having a coupling end connected or connectable to one or more of the backing members and a distal free end that is located opposite to the attachment end in the width direction of the side member;
wherein each side member, at the coupling end thereof, comprises a coupling feature that is cooperable or in cooperation with a mating coupling feature at the perimeter of one or more of the backing members to couple the side member to the backing member in the useful position.

2. The nest surround of claim 1 wherein each side member has the same coupling feature at the coupling end thereof and each backing member has the same mating coupling feature at the perimeter thereof, and each side member is connectable to any of said backing members.

3. The nest surround of claim 1 wherein the backing members are identical to one another.

4. The nest surround of claim 1 wherein each backing member has the coupling feature on multiple sides of the perimeter thereof.

5. The nest surround of claim 4 wherein the perimeter of each backing member has four sides, and each backing member has the coupling feature on three of the four sides.

6. The nest surround of claim 5 wherein each backing member has the coupling feature on only said three of the four sides.

7. The nest surround of claim 1 wherein the coupling features of the side members comprise male or female profiles, and the mating coupling features of the backing member comprises mating male or female profiles.

8. The nest surround of claims 7 wherein each side member comprises has a thin-walled structure of lesser thickness than each backing member, the coupling feature of each side member comprises a female profile, and the mating coupling feature of each backing member is a male profile fittable into said female profile.

9. The nest surround of claim 1 wherein each side member is flexible.

10. The nest surround of claim 1 wherein at least some of the coupling features of the side members, and respective mating coupling feature of the backing members, are arranged to angle respective side wall members inwardly over the common plane of the backing members in the useful position.

11. The nest surround of claim 1 wherein at least some of the mating coupling feature of the backing members are oriented at an obliquely offset angle relative to a primary plane that occupies the common plane during use of the nest surround.

12. The nest surround of claim 1 wherein at least some of the coupling features of the side members are oriented in an obliquely offset relation to a primary plane of the side member in which the width and length dimensions are measured.

13. The nest surround of claim 1 wherein a first one of either the coupling features of the side members or the matable coupling features of the backing members comprises a groove, and the other one of either the coupling features of the side members or the matable coupling features of the backing members comprises a mating tongue slidably receivable in the groove.

14. The nest surround of claim 13 wherein each groove and the mating tongue comprise opposite ones of a lock protrusion and a lock recess which cooperate with one another to secure the side wall in place under relative sliding of the tongue and groove into a secured position aligning the lock recess over the lock protrusion.

15. The nest surround of claim 14 wherein the lock protrusion comprises a ramp-shaped protrusion in the groove and the lock recess comprises a corresponding notch in the tongue.

16. The nest surround of claim 1 wherein each backing member comprises a plurality of feet projecting from a main body of the backing member to a side thereof opposite to that to which the side members extend in the useful position at locations situated inwardly from the mating coupling features of the backing member.

17. The nest surround of claim 1 wherein each backing member comprises sunken well that is offset from a main body of the backing member to a side thereof opposite to that to which the side members extend in the useful position, and a hanging slot is defined in a wall of the sunken wall that lies opposite to the main body for hanging support the nest surround through said hanger opening.

18. The nest surround of claim 1 wherein the coupling feature of each side member comprises a C-shaped channel opening laterally to one side of the side member, and each mating coupling feature of the backing members comprises a protrusion having a neck of reduced thickness relative to a head of the protrusion that is carried at an outer end of the neck, the C-shaped channel embracing around the head of the protrusion and being slidable along the neck thereof.

19. The nest surround of claim 1 wherein each side member comprises a Z-shaped profile at the distal end thereof that extends laterally to a same side of the side member as the coupling feature.

20. A nest surround for a leafcutter bee nest block, the nest surround comprising:
at least one backing member for defining a backing of the nest surround; and
a plurality of separate side members having a length dimension and a width dimension and being connected or connectable to the at least one backing member in useful positions in which the width dimensions of the side members extend away from the backing and the length dimensions span along respective sides of the backing;
each of the side members having a coupling end connected or connectable to the at least one backing member and a distal free end that is located opposite to the attachment end in the width direction of the side member;
each side member, at the coupling end thereof, comprising a coupling feature that is cooperable or in cooperation with a mating coupling feature at a perimeter of the at least one backing member to couple the side member to the at least one backing member in the useful position;
wherein the coupling features of the side members comprise male or female profiles, and the mating coupling features of the backing member comprises mating male or female profiles slidably engagable with the male or female profiles of the slide members for sliding movement between the male or female profiles and the mating male or female profiles along the perimeter of the at least one backing member.

21. The nest surround of claim 20 the female profiles comprise respective grooves, and the male profiles comprise mating tongues slidably receivable in said grooves.

22. A nest surround for a leafcutter bee nest block, the nest surround comprising:
at least one backing member for defining a backing of the nest surround; and
a plurality of side members connected or connectable to the at least one backing member in useful positions in which the width dimensions of the side members extending away from the backing along respective sides of the backing;
wherein each side member has a Z-shaped profile at a distal end thereof that lies furthest from the backing in the useful position of the side member.
